(19) United States
(12) Patent Application Publication
(10) Pub. No.: US 2014/0242476 A1
(43) Pub. Date: Aug. 28, 2014

(54) OPERATING BATTERY STACK SYSTEM PERFORMANCE BY ALTERNATING THE FLOW OF HEAT CARRYING FLUID USED THEREIN

(71) Applicants: Michael Kühne, Furth (DE); Arun K. S. Iyengar, Delmont, PA (US)

(72) Inventors: Michael Kühne, Furth (DE); Arun K. S. Iyengar, Delmont, PA (US)

(21) Appl. No.: 13/780,317

(22) Filed: Feb. 28, 2013

(51) Int. Cl. C25B 15/02; H01M 8/04; H01M 10/50

(52) U.S. Cl. CPC C25B 15/02; H01M 10/5008; H01M 8/04007
USPC 429/407; 429/72; 429/434; 204/274; 204/262

(57) ABSTRACT

What is provided is an operating battery stack system (24) with interconnector plates (20) and in and out heat transfer fluids (22), where the fluids, which can be liquid or gaseous, function as heat transfer media, to pass between each interconnector plate (20) in countercurrent direction to extract heat from the battery system (24) permitting heat exchange (28) in a direction perpendicular to the fluid (22) flow and plate axis (26) resulting in lowered temperature gradients within the stack.

### BACKGROUND

1. Field

This present invention relates to advanced battery systems and operating battery stacks, including advanced ROBs (Rechargeable Oxide-Ion Batteries), fuel cells and advanced electrolysis systems, having heat carrying gas or liquid fluids in contact with electrodes and interposed electrolytes, which fluids are directed/disposed in such a way that the flow of heat within the operating battery stack alternates from electrode/electrolyte/electrode layer to layer, and heat exchange is mainly in a dimension perpendicular to the fluid flow.

2. Description of Related Art

Electrochemical processes can be employed either to convert electrical energy into chemical energy or to use available chemical energy for the production of electricity. An example for the first case (chemical synthesis) is the electrolysis of water to hydrogen and oxygen; an example for the latter process is a fuel cell using a fuel gas (like hydrogen or a reformed gas mixture) and oxygen from air.

For technical simplicity, cost, weight or space limitations, several single electrochemical cells (repetitive units) are put together to form one common electrochemical reactor which is called a cell stack. Also rechargeable battery assemblies may be built as stacks. In the latter case, one has to combine the capability for the production of chemical reagents from electricity (charging mode) with the re-conversion of the reagents' chemical energy into electricity (supply of electricity, battery discharge) in one functional stack unit.

One very important accompanying feature of electrochemical reactions is the generation or absorption of heat in a sensible form. Irreversible internal losses due to current and mass transport phenomena or kinetic inhibition at the electrode surfaces add to the overall heat balance.

Heat imbalances arise within the cell stack that either balance out by themselves through heat conduction or have to be compensated by special design features to maintain temperatures within desired limits. Heat transport may be improved by employing the electrochemical reagents, if fluid, also as a heat carrier. In such a case, additional design features to effectively exchange heat between the carrier fluid and the cell stack are needed. Another way to effectively transport heat in or out of the stack would be the employment of two heat exchangers, one of them being stack-internal, the second being in contact with the (external) environment, and the two being thermally coupled through a separate fluid circuit. For the sake of simplicity; each embodiment of “stacks” mentioned before with integrated chemical reagent and heat management system shall be called a “battery.”

“Batteries” are by far the most common form of storing electrical energy in form of chemical energy, ranging from: standard every day lead-acid cells, nickel-metal hydride (NiMH) batteries taught by Kitayama in U.S. Pat. No. 6,399,247 B1, metal-air cells taught by Isenberg in U.S. Pat. No. 4,054,729, microcell electrical devices taught by Eshraghi, in U.S. Pat. No. 6,399,232 to the lithium-ion battery taught by Ohata in U.S. Pat. No. 7,396,612 B2.

“Batteries” range in size from button cells used in watches, to megawatt load leveling applications. They are, in general, efficient storage devices, with output energy typically exceeding 90% of input energy, except at higher power densities. In the context of this invention, however, only the part of battery technologies employing fluids as heat carrying mediums are relevant.

Fuel cell systems are special types of “batteries” which are usually employed in system sizes starting at the two-digit kW-range and reaching up to some MW of output power. The most common fuel cell technologies are polymer electrolyte based PEMFC, phosphoric acid based PAFC, carbonate melt based MCFC, or solid oxide based SOFC. They all usually employ gaseous fuels, either pure hydrogen or reformed gasses, and oxygen or air as oxidant. They all have in common, that besides chemical agents and electricity, the heat balance of each cell and the cell stacks as a whole has to be managed in a proper way. The same logic applies to the reverse reaction of fuel cells, i.e. electrolysis. For instance, one has to supply H₂O vapor and heat to a solid oxide water electrolysis stack, if the electrolysis voltage is kept at moderate levels below the thermo-neutral value of about 1.4 V per cell.

One of the main problems in the area of battery technologies employing heat carrying mediums is that, often, customer requirements include quick system reactions to load changes, high system efficiency targets, and limited available space for the key components at the same time. Hence, in advanced “batteries,” the need for effective heat compensation may become a major challenge: for the sake of high power densities, one often accepts a trade-off between higher temperature gradients and lower ancillary power for pumping the heat carrying fluid. Temperature gradients on their turn, especially if varying in time, induce thermal stresses upon the stack components. With existing compromises, customer requirements may remain unaddressed, operation conditions be confined to slower load changes, operation life be shortened, service efforts be increased, or even the risk of premature system or component failure be accepted.

Operating battery stacks are usually built by assembling a predefined number of MEAs (“membrane electrode assemblies”, active parts of a battery) with passive separator plates or “interconnectors,” in such a way that:
each electrode compartment or its adjacent interconnector plate may be replenished with fluids (reagents and/or coolants) needed for proper and continuous function of the battery,
electronic conduction is achieved by electrically connecting single cells through the interconnector in series,
heat transport is achieved by circulation of a heat carrying fluid between the location of heat production and the heat exchanging device, and
the heat carrying fluid may be kept in an independent loop and separated from any reagents in case all three media are different.
   Often, significant temperature gradients may have to be accepted during operation of the device.

Simple, lower cost solutions have to cope with longer start-up times of the battery system or a more sluggish reaction to a request for quick load change in order to protect the battery from excessive stress and premature failure. More advanced solutions are based on the engineering of an intricate system of fluid channels, plenums and manifolds. Often, elaborate fluid models are created and analyzed in order to find the optimum of technical feasibility on the one side and reliability and lifetime on the other. A main problem of most systems established in the market is that the temperature gradient is established parallel to the flow direction of the heat carrying fluid. Thermal expansion and material stability considerations will lead the supplier of the system under consideration to precisely define and adequately limit the allowable operation conditions to a well tested and proven parameter regime.

One main object of this invention is to provide a solution to the temperature gradient and thus thermal stress problems described above.

One type of advanced battery system is taught by U.S. Patent Publication No. 2011/0033769 (now U.S. patent application Ser. No. 12/695,386, filed Jan. 28, 2010) and U.S. application Ser. No. 13/651,518, filed Oct. 15, 2012 (Attorney Docket No. 2011E07125US); the latter relating to an advanced, rechargeable oxide-ion battery (ROB) cell stack, illustrated generally in FIG. 1, which relates to a low cost rechargeable oxide-ion battery (ROB) cell and stack, with emphasis on the geometry of a thin metal bipolar housing that could be manufactured using existing low-cost stamping, hydro-forming, or electroforming fabrication methods, and use of gas feed plenum geometry therein.

This metal bipolar housing 13 (which may be interchangeably described as bipolar plate or interconnector plate) in FIG. 1 has a thickness of, generally, from about 0.1 cm to 0.75 cm. These ROB battery cell stacks 10′ have cells 10 with a total thickness ranging from about 0.3 cm to 2.5 cm, with a cost savings in materials and processing over cast, milled/machined, or powder formed products. A plurality of these ROB cells 10 form a ROB stack 10′, having interior MEA (membrane electrode assembly)-carrying frames 40 there between and having air inlet and exhaust plenums, formed by openings for incoming air 16 and air exhaust 17. An optional auxiliary gas is shown as dotted lines 18 and 18′. Optional auxiliary inlet and exhaust plenums, shown as 19 and 19′, also form when units are combined. The MEA (membrane electrode assembly) is shown as 37, containing positive and negative electrodes being in contact with the respective side of the bipolar housings 13 located above or below the MEA. Interior channels 14 within the interconnector plate 13 provide air passage for the air electrode; and opposed channels provide for deposition of fuel electrode active material (not shown for sake of simplicity). The primary gas 16 is air and the optional auxiliary gas 18 may be steam and/or hydrogen.

The prior art shows uniform horizontal fluid gas flow 22 direction over all cells within the stack leading to a temperature bias across the stack that needs to be mitigated.

### SUMMARY

The above objectives are met and problems solved, by providing an operating battery stack, where heat is generated during operation, comprising:
a) at least two adjacent electrochemical cells, each comprising positive and negative electrode compartments, separated by an ion-selective membrane/separator;
b) a heat-conducting interconnector plate, having a plate axis, between the at least two adjacent cells;
c) a heat-carrying fluid passing through at least one, either positive or negative electrode compartment of the cells parallel to the plate axis of the interconnector plate; whereby the flow of the heat-carrying fluid is inversed in the adjacent electrochemical cell with respect to the first electrochemical cell, to provide heat exchange in a direction perpendicular to the fluid and the interconnector plate axis;
d) means to direct the flow of the heat carrying fluid from an external plenum to the at least two adjacent electrochemical cells and distribute the flow between the cells; and
e) means to collect electricity generated by the operating battery stack.

If the battery stack is a metal air system, the heat carrying fluid may be air comprising oxygen as reactive agent either being produced (charging of the battery, under possible consumption of heat) or being consumed (during battery discharge, e.g. under parallel release of heat).

If the battery stack is a high temperature fuel cell system with an immobile electrolyte (PAFC, MCFC, or SOFC, i.e., phosphonic acid, molten carbonate or solid oxide electrolyte fuel cells), there will be two fluids, first the fuel itself (usually H₂ or a reformed natural gas mixture) and second the gaseous oxidant (usually oxygen or air). Within the context of this invention, the fluid with the higher capacity to absorb or release heat, which—in absence of internal reformation—is usually the fluid with the higher flow rate (in m³/s) will have to be considered as the heat carrying fluid.

If the battery stack is a high temperature electrolysis system with an immobile electrolyte (SOEC—solid oxide electrolysis cell), there will be essentially one fluid being injected into a negative cell compartment (i.e. water vapor), and two effusing gasses (i.e., moist hydrogen at the negative electrode, and oxygen at the positive anode).

If the battery stack is a low temperature electrolysis system based on a polymer electrolyte membrane (PEM), the flow of liquid water which because of its high heat capacity will essentially determine the temperature distribution within the stack.

The present invention comprises several embodiments of electrochemical operating battery stacks, including but not being limited to a)-u):
a) the heat carrying fluid may be gaseous;
b) the heat carrying fluid may be liquid;
c) the heat carrying fluid may be a chemically active substance contributing to the cell electrochemistry (like oxygen) or an inert, non-reactive substance, either pure or mixed with chemical reagents (like nitrogen or vapor) passed through the cell;
d) the heat carrying fluid may be passed also through an interconnector/separator plate either heating the stack or cooling the same (this invention requires alternating flow directions from cell to cell);
e) the battery stack may be part of an alkaline fuel cell system (AFC);
f) the battery stack may be part of a polymer electrolyte membrane fuel cell system (PEMFC);
g) the battery stack may be part of a phosphoric acid fuel cell system (PAFC);
h) the battery stack may be part of a molten carbonate fuel cell system (MCFC);
i) the battery stack may be part of an solid oxide fuel cell system (SOFC);
j) the stack may be part of an alkaline electrolysis cell system (AEC);
k) the battery stack may be part of a polymer electrolyte membrane electrolysis cell system (PEM-EC);
l) the battery stack may be part of an solid oxide electrolysis system (SOEC);
m) the battery stack may be part of a metal air cell, from ambient to high temperature technologies;
n) bipolar interconnector plates may be built in a mirror-symmetric way, i.e. using two, not interchangeable interconnector plates;
o) bipolar interconnector plates may be built in an asymmetric way, i.e. using only one type of an interconnector plate that is rotated by 180° from cell to cell in such a way that the direction of heat carrier flow is reversed from cell to cell;
p) the above asymmetric interconnector plates may be made to host one or more single electrochemical cells; and
q) the fluid on one side of the electrode may be a gas, and on the other side of the electrode, may be a liquid. In such a case, the preferred embodiment would be an alternating flow of a liquid heat carrier.

The invention is also meant to include:
r) if the stack is a rechargeable battery, the flow direction may be maintained constant when the current is reversed (i.e. when operation is switched from charging to discharge mode or vice versa), or it may be reversed;
s) all methods of assembling the above mentioned battery stack arrangements;
t) all systems comprising the above mentioned battery stack arrangements; and
u) operation of any battery stack system described above.

### BRIEF DESCRIPTION OF THE DRAWINGS

A further understanding of the invention can be gained from the following description of the preferred embodiments when read in conjunction with the accompanying drawings in which:

FIG. 1 is a prior art representation showing a three-dimensional view that illustrates a complete ROB battery stack showing vertical and horizontal gas flow through gas plenums in which the gas flow is all in one direction on one side (up) and all in one direction on the other side (down);

FIG. 2, which best illustrates the invention, shows one embodiment of this invention, where a ROB battery stack, in accordance with this invention, utilizes alternating horizontal gas flow, with a vertical heat transfer flow;

FIG. 3, which describes one embodiment of the invention, is a schematic representation of a battery system with alternating horizontal flow of heat carrying fluid; assuming two separate interconnector plate designs A and B; Note that, adjacent to the gas distribution channels within the bipolar housing 20, can be either the anode or the cathode electrode plate depending on the design. This design requires the manufacturing of two different cell plates, each with its own air inlet and exhaust plenums and assembled in a fashion such that the direction of the flow of the heat carrying fluid 22 alternates between two adjacent cells;

FIG. 4 shows a schematic embodiment representation of an alternate battery system whereby the alternating flow of the heat carrying fluid, can be achieved by assuming one common plate design C and rotating it by 180° to yield C*for its immediate neighbor; and

FIG. 5 shows another embodiment of FIG. 2.

### DESCRIPTION OF THE PREFERRED EMBODIMENTS

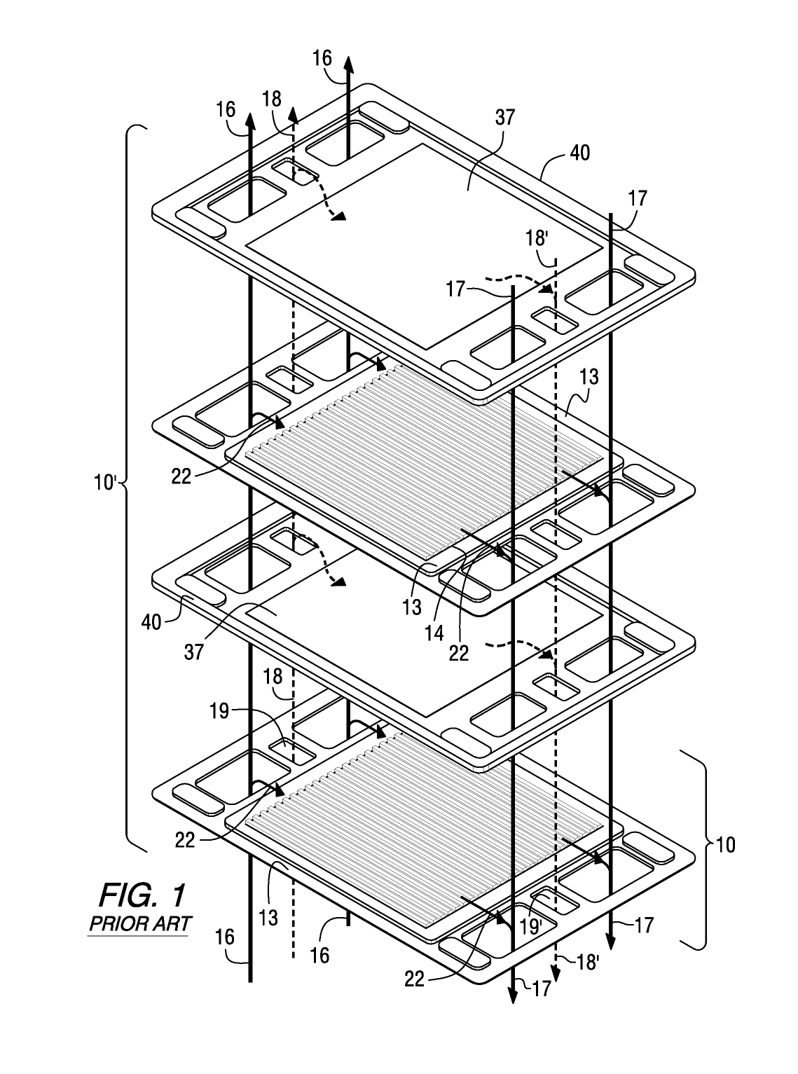

The present invention is designed to reduce the thermal stress imposed on a metal oxide battery stack as described in detail in the prior art ROB example FIG. 1. In that prior art, there is essentially one fluid heat carrier (air) which is of relevance at the operation temperature somewhere between 700° C. to 900° C. The openings 18 in prior art FIG. 1 are for an optional auxiliary gas (moisture or H₂) that, for the small volumes and gas flow rates, are not relevant in the context of the heat distribution considerations made in this invention.

The alternating gas flow directions of this invention refer to one and the same gas species, i.e. air. This way, in a first cell plane heat is transported to one side whereas in an adjacent cell plane (above or below), the transport direction is opposite to the first one.

The principle of this invention may be applied also to other electrochemical stacks, like fuel cells or electrolysis cells, which are considered covered in this invention broadly as a “battery stack.” However, they may use various fluids such as fuel, air, and even a third liquid heat carrier passed through a special heat exchanging device, like a cooling plate, which may comprise variations like a meander-shaped tubing or fluid channels inserted within the flat interconnector structure as may be used in membrane fuel cells.

Relevant within this invention is the focus on the one and only fluid which has the highest heat transporting potential. This potential is given essentially by a) the heat capacity, b) the flow rate of the heat carrier.

In some prior art fuel cells (e.g., SOFC technology) the gas flow directions of fuel and air are opposite, i.e. fuel may flow from “left to right” in all cells, whereas air would flow “from right to left.”

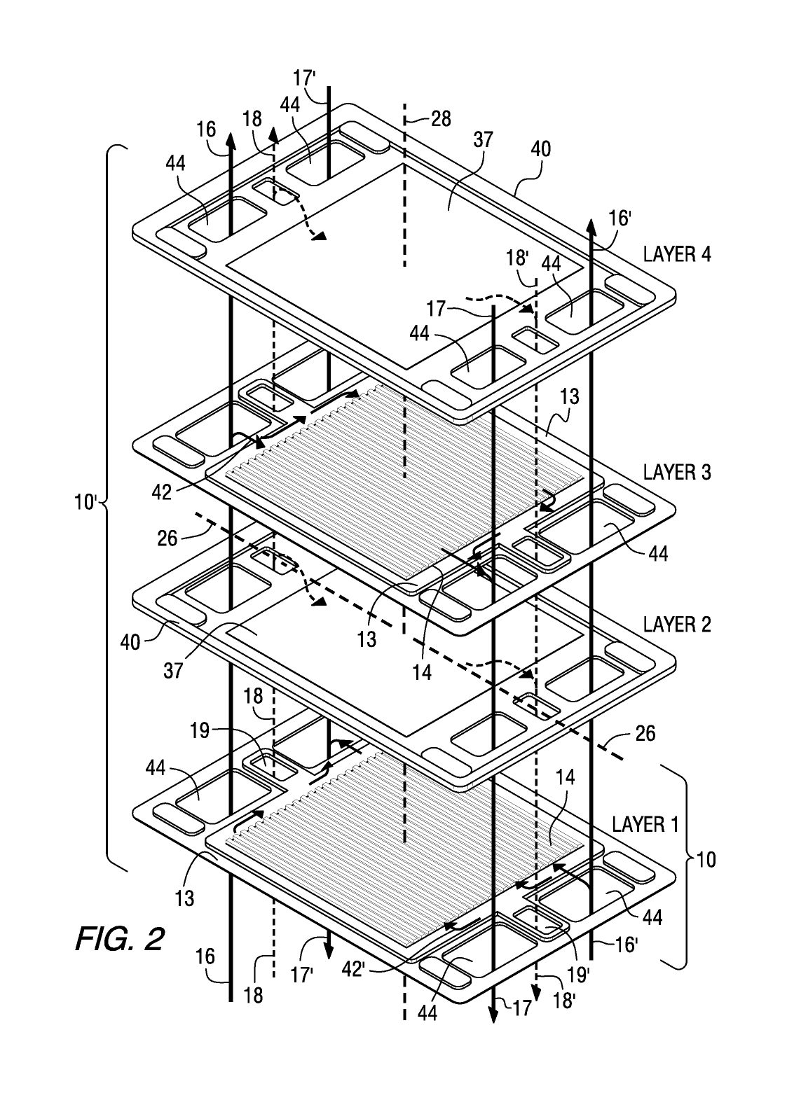

Referring now to FIG. 2, which for sake of comparison to prior art FIG. 1, shows an operating battery stack 10′ with layers 1-4 and a plurality of adjacent electrochemical cells 10 having positive and negative electrode compartments, given generally by the space between MEA 37 and interconnector plate 13. The MEA 37 comprises the positive and negative electrodes which are separated by ion-transfer/ion-selective membrane or separator. A heat-carrying fluid flow 42, 42′ passes through at least one positive or negative electrode compartment, so the fluid flow is inversed/reversed with respect to the adjacent cells; right to left fluid 42′ in layer 1 versus left to right fluid 42 in layer 3 in a direction parallel to the axis 26 of the plates. This flow provides heat exchange 28 in a direction perpendicular to the fluid flow 42 and 42′ and the plate axis 26. A pump means or other means (now shown) directs the flow of fluids 42 and 42′, from external plenums, one part/component of which is shown as 44 to distribute heat 28 between the cells 10. The operating battery stack generates or absorbs heat, as is well known, which may be collected for further use.

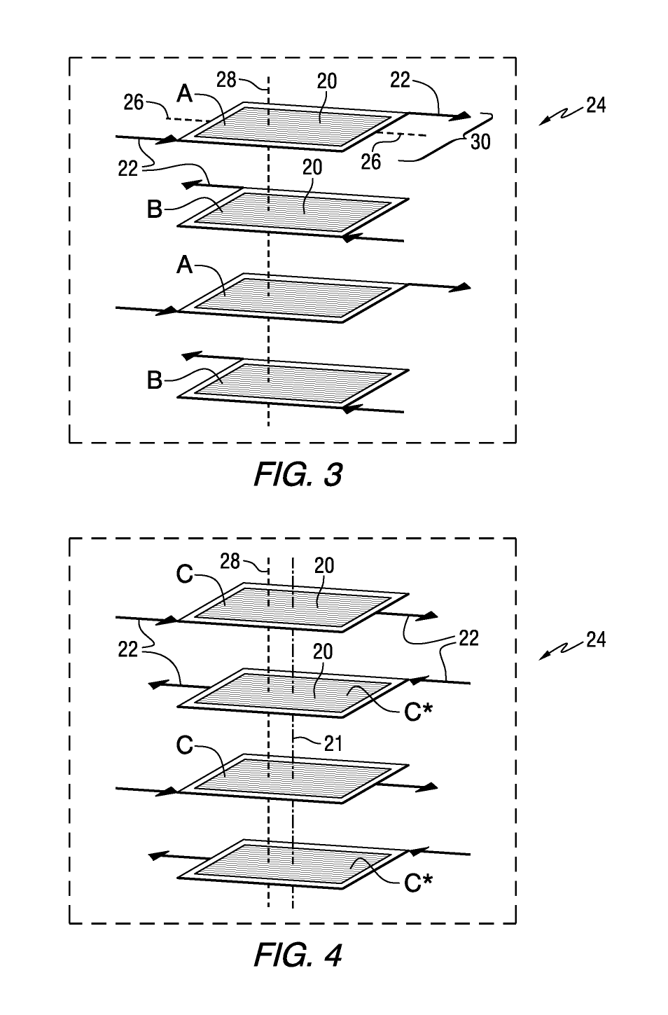

In this invention, referring now to FIG. 3, where a battery stack system 24, dotted lines, is shown in idealized form, eliminating components such as MEAs and MEA-frames for sake of more clearly showing the fluid transfer media flow paths. Interconnector plates are generally shown as 20 and the flow of a heat exchanging fluid, such as air is shown as 22, while heat exchange is shown as 28. The plate axis is shown as 26 and a layer is shown as 30.

These interconnector plates 20 are designed in such a way that the flow of the heat carrying fluid 22 alternates from layer to layer—A to B. As shown in FIG. 3, in the first layer A the fluid is designed to flow from the left side to the right, in the second layer B from the right side to the left, in the third layer from left to right, as in the first layer, and so on.

With alternating flow of the heat carrying fluid between electrode/interconnector plates, heat exchange 28 is achieved between the layers A and B, that is, in the third dimension perpendicular to the interconnector plate plane, axis 26, and fluid flow 22, along the stacking direction of the single layers.

Temperature gradients will thus become considerably smaller with respect to the conventional stack design for a given flow rate of the heat carrying fluid. “Conventional” in this sense means a stack of exclusively one layer type (e.g., only layers of type A in FIG. 3). The heat carrying fluid, in a conventional stack, would flow either from left to right, or vice-versa. Alternately, for an acceptable temperature gradient, the proposed design requires much lower flow rates than the conventional design, for example, about 250 ml/sec or about 250 cubic cm/sec vs. prior 500 ml/sec; showing an enhancement of overall system efficiency due to lowered ancillary pumping losses.

As a consequence of heat exchange between layers A and B, cyclic thermal stress will be reduced in the embodiment of FIG. 3. This remains valid even in the case when the stack power is modulated or if the current direction is reversed: variations of time are reduced also in this case. A further possibility is to impose more severe load changes without reaching the stress levels that would occur with the conventional stack design.

Not shown, for simplicity in FIG. 3 are the membrane electrode assemblies and the air and exhaust plenums that feed the channels of the interconnector plate 20. The power collecting devices and the electrical connections at the end plates/terminals of the stack are also not shown.

By a special asymmetric design of the plates, an alternating flow of the heat exchanging fluid is achieved. One possible embodiment is shown in FIG. 3, there, plates A and B can be inversed (mirror-inverted) design, two separate plate designs would be necessary in that case.

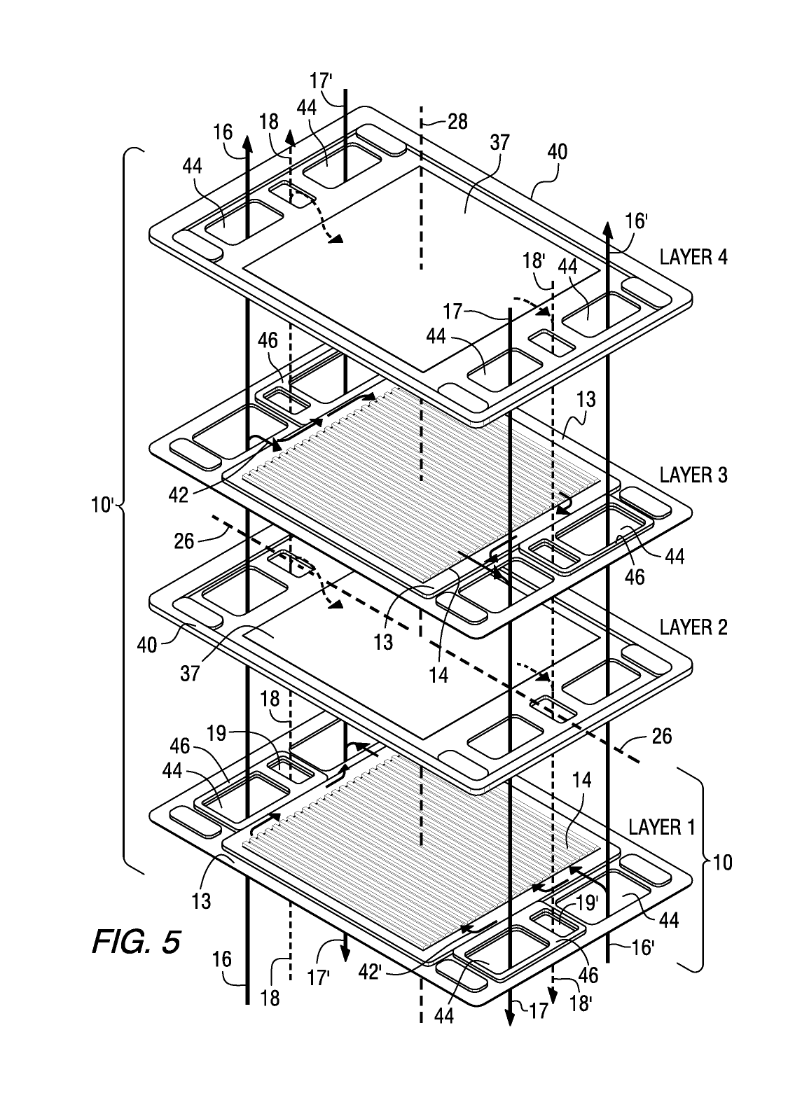

Another possibility would be the following embodiment of battery stack system 24, shown in FIG. 4 which needs only one rather than more than one bipolar plate 20. Layers of C and C*, bipolar plate/electrode 20 in FIG. 4 are now identical in design, but just rotated by 180° with respect to each adjacent layer. Just by different orientation they assume a different functions within the stack. In layer C, the fluid transport 22 is from left to right, and in the case of C*, from right to left. The position of symmetry axis 21 for rotation is also shown.

Whereas in FIG. 1, two parallel manifolds 16 are positioned at one side of the stack for the air inlets and another two parallel manifolds 17 are located at the other side for the air outlets, FIG. 2 shows a different embodiment. In order to realize the inversed/reversed air flow with respect to the adjacent cells 10, the manifolds 16 and 16′ for the gas inlets and 17 and 17′ for the gas outlets, respectively, are positioned at opposite sides of the stack; hence, manifold 16 is parallel to manifold 17′ whereas manifold 16′ is parallel to manifold 17. One possible detailed design of the embodiment introduced with the basic design FIG. 4 is shown in FIG. 5. Simply by introducing a suitable gasket or heightening around the openings for manifolds 16 and 17 in layer 1 of the stack, it becomes possible to direct the gas flow between the interconnector plate 13 and the MEA frame 40 directly from gas inlet 16′ to gas outlet 17′. The same interconnector design of layer 1 may then be rotated by 180°, and the design shown in layer 3 is obtained. Now the gaskets/heightenings are located around gas inlet 16′ and gas outlet 17′, i.e., preventing air flow from or to these manifolds, and directing the air directly from gas inlet 16 to outlet 17. The layer 5 (not drawn) would then be of the same design as layer 1, layer 6 would be identical to layer 2, and so on.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. An operating battery stack, where heat is generated during operation, comprising:
a) at least two adjacent electrochemical cells, each comprising positive and negative electrode compartments, separated by an ion-selective membrane/separator;
b) a heat-conducting interconnector plate, having a plate axis, between the at least two adjacent cells;
c) a heat-carrying fluid passing through at least one, either positive or negative electrode compartments of the cells parallel to the plate axis of the interconnector plate; whereby the flow of the heat-carrying fluid is inversed in the adjacent electrochemical cell with respect to the first electrochemical cell, to provide heat exchange in a direction perpendicular to the fluid and the interconnector plate axis;
d) means to direct the flow of the heat carrying fluid from an external plenum to the at least two adjacent electrochemical cells and distribute the flow between the cells; and
e) means to collect electricity generated by the operating battery stack.

2. The operating battery stack of claim 1, wherein fuel and oxidant are fed to respective positive and negative electrodes.

3. The operating battery stack of claim 1, wherein the battery stack is selected from the group consisting of a ROB battery system and a fuel cell system.

4. The operating battery stack of claim 1, wherein the heat-carrying fluid is a gaseous media selected from the group consisting of gaseous fuel and gaseous oxidant.

5. The operating battery stack of claim 4, wherein the gaseous fuel comprises hydrogen.

6. The operating battery stack of claim 4, wherein the gaseous oxidant is air.

7. The operating battery stack of claim 1, wherein such stack is a metal-air system, where the heat carrying fluid is air, comprising oxygen.

8. The operating battery stack of claim 1, wherein such stack is a high temperature fuel cell system with an immobile solid electrolyte, where there are two fluids, the first being the fuel itself selected from the group consisting of H₂ or a reformed natural gas mixture and the second a gaseous oxidant.

9. The operating battery stack of claim 1, wherein such stack is a high temperature electrolysis system with an immobile solid electrolyte, where there is one fluid comprising water vapor injected into a negative cell compartment, and two effusing gasses consisting essentially of moist hydrogen at the negative electrode, and oxygen at the positive electrode.

10. The operating battery stack of claim 1, wherein such stack is a low temperature electrolysis system based on a polymer electrolyte membrane, where the flow of liquid water is the heat carrying fluid which because of its high heat capacity will essentially determine a temperature distribution within the stack through a heat exchanging device selected from a cooling plate inserted between the electrodes or integrated within the interconnector layer.

11. The operating battery stack of claim 1, wherein the heat carrying fluid may be either gaseous or liquid.

12. The operating battery stack of claim 1, wherein the heat carrying fluid is selected from a chemically active oxygen contributing to cell electrochemistry or an inert, non-reactive substance, selected from pure or substance mixed with chemical reagents.

13. The operating battery stack of claim 1, wherein the heat conducting fluid is passed also through an interconnector plate to either heating the stack or cool the stack.

14. The operating battery stack of claim 1, wherein the stack is part of an alkaline fuel cell system (AFC).

15. The operating battery stack of claim 1, wherein the stack is part of a polymer electrolyte membrane fuel cell system (PEMFC).

16. The operating battery stack of claim 1, wherein such stack is part of a phosphorous acid fuel cell system (PAFC).

17. The operating battery stack of claim 1, wherein stack is part of a molten carbonate fuel cell system (MCFC).

18. The operating battery stack of claim 1, wherein the stack is part of a solid oxide fuel cell system (SOFC).

19. The operating battery stack of claim 1, wherein the stack is part of an alkaline electrolysis cell system (AEC).

20. The operating battery stack of claim 1, wherein the stack is part of a polymer electrolyte membrane electrolysis cell system (PEM-EC).

21. The operating battery stack of claim 1, wherein the stack is part of a solid oxide electrolysis system (SOEC).

22. The operating battery stack of claim 1, wherein the stack is part of a battery system.

23. The operating battery stack of claim 1, wherein the interconnector is a bipolar interconnector plate constructed in a mirror-symmetric way.

24. The operating battery stack of claim 1, wherein the interconnector is a bipolar interconnector plate constructed in an asymmetric way, using only one type of an interconnector plate that is rotated by 180° from cell to cell in such a way that the direction of heat carrier fluid flow is reversed from cell to cell.

25. The operating battery stack of claim 1, wherein the heat carrying fluid on one side of the electrode compartment is a gas, and on the other side of the electrode compartment is a liquid.

26. The operating battery stack of claim 1, wherein the battery stack is a rechargeable battery, where the flow direction of the heat carrying fluid is maintained constant when the current is reversed, when operation is switched from charging to discharge mode.
